(19) United States
(12) Patent Application Publication
(10) Pub. No.: US 2004/0061704 A1
(43) Pub. Date: Apr. 1, 2004

(54) Memory access method for video decoding

(76) Inventors: Chi-Cheng Ju, Taipei (TW); Jeffrey Ju, Hsinchu (TW)

Correspondence Address: BIRCH STEWART KOLASCH & BIRCH, PO BOX 747, FALLS CHURCH, VA, 22040-0747, US

(21) Appl. No.: 10/256,020

(22) Filed: Sep. 27, 2002

(51) Int. Cl. G06T 15/30; G06T 17/20; G06F 12/00

(52) U.S. Cl. 345/564

(57) ABSTRACT

A memory access method for video decoding is provided. More particularly, a method of storing pixel data of a reference picture and retrieving a prediction block of the reference picture from a memory is provided. The memory is divided into several pages. The reference picture consists of a top field and a bottom field, and is divided into several macroblocks. Each macroblock has a corresponding portion of the top field and the bottom field. The method includes the steps of: dividing each page into a top-section having one or more consecutive addressing area and a bottom-section having one or more consecutive addressing areas; storing the corresponding top field and corresponding bottom field of the macroblocks into the top-sections and bottom-sections, respectively; and then retrieving the pixel data of the prediction block stored in the memory in a page-by-page manner.

### BACKGROUND OF THE INVENTION

1. Field of the Invention

The invention relates to a memory access method, and in particular to a memory access method in which a picture is divided into several macroblocks and stored in the memory block by block, and the top and bottom field of each macroblock are separately stored in different consecutive addressing areas of pages. According to this method, the DRAM burst mode can be utilized for both frame and field access to substantially increase effective DRAM bandwidth. In this way, inefficient DRAM access for wider DRAM data bus width in the frame-organized method can be avoided, and cross-page penalty in frame access in the field-organized method can also be avoided.

2. Description of the Related Art

In current video decoding systems, such as MPEG-I, MPEG-II, H.261, and the like, the inter-frame compression technology is often used to reduce the data redundancies between pictures so as to obtain a better data compression result. The systems all involve algorithms based on a common core of the compression technology, such as predictive and/or inter-polative inter-picture encoding. The motion compensation is block-based, and each prediction block has associated motion vectors. The motion compensation operation involves reading the prediction block from a reference picture according to the motion vectors. A reference picture is used for forward and backward prediction. The reference picture can be either a reference-frame-picture, or a reference-field-picture having one reference-top-field-picture and one reference-bottom-field-picture. A reference-frame-picture is encoded as a frame picture, and contains lines of spatial information of a video signal. These lines of spatial information contain samples starting from the uppermost of the picture continuing through successive lines to the downmost of the picture. A reference-field-picture is encoded as a field picture, and is the assembly of alternate lines of a frame. Each line of a reference-top-field-picture is spatially located immediately above the corresponding line of the reference-bottom-field-picture. The reference pictures are quite large and typically stored in dynamic random access memories (DRAMs). The DRAM has several memory banks, and each bank includes many memory pages. However, there is a problem of cross-page penalty in the DRAM. The DRAM can be addressed by the column address and the row address, and a different row address may be addressed to a different page. Before reading the data in different pages, it is necessary to activate and pre-charge the to-be-read page. Consequently, reading the data from different pages may slow down the speed for the video decoder to read the reference picture. In order to mitigate the cross-page penalty, it is desired to store each prediction block into fewer pages during data accessing, and then to access data in a page-by-page manner.

The increasing demand for more memory bandwidth requires the use of sophisticated memory devices like DDR SDRAM or RDRAM (Rambus DRAM). To obtain high performance, these devices have two main features: the burst-access mode and the multiple-bank architecture. The burst-access mode enables access to a number of consecutive addressing data words by simply giving a burst read command or a burst write command. The burst read command or burst write command includes a burst-starting-address indicating the starting address of the data to be retrieved, and a burst-access-length indicating the size of the data to be retrieved. The multiple-bank architecture has the feature that each bank can be accessed alternately. A burst access operation majorly includes three steps. Firstly, issue a row-activation command so as to copy the row data of a designated bank into the sense amplifier. Secondly, issue a burst access command to fetch data of the size indicated in the burst-access-length from the sense amplifier and then send the fetched data to the data bus. Thirdly, access data stored in other columns but in the same row by changing only the column address without issuing any additional row-activation command. Since these steps are pipelined with an external clock, SDRAM or RDRAM can operate at higher clock frequency, and commands issued to different banks can be overlapped. For example, a row-activation command of one bank can be overlapped with burst access operations of another bank. So the number of cycles for the row-activiation can be reduced. Therefore, if we can access the reference picture by burst access mode, the effective DRAM bandwidth can be greatly boosted up.

In a typical video decoding system, a reference picture has two fields, i.e., top field and bottom field. The top field includes all the odd number data rows in the reference picture, while the bottom field includes all the even number data rows in the reference picture. The top field and the bottom field can be samples retrieved at the same or different time instant in the time axis. To achieve the best compression ratio and reconstructed image quality, frame-based prediction and field-based prediction mode are used. The frame-based prediction is a prediction mode using both the top field and bottom field of the reference picture, and the field-based prediction is a prediction mode using only one field of the reference picture. In the case that the top and bottom fields of the frame are sampled at a same time instant, frame-based prediction is used. In the case that the top and bottom fields of the frame are sampled at a different time instant, field-based prediction is used. In another aspect, since the reference picture can be divided into many macroblocks, each macroblock includes a portion of the top field and a portion of the bottom field. The specific portion of the top field belonging to a macroblock will be described as “the corresponding top field of the macroblock” in the following description. Similarly, the specific portion of the bottom field belonging to a macroblock will be described as “the corresponding bottom field of the macroblock.”

To perform the motion compensation operation in a frame-based prediction, the frame access method that concurrently accesses both the top field and bottom field is used. On the other hand, to perform the motion compensation in a field-based prediction, the field access method that accesses either the top field or the bottom field is used.

FIG. 1 is a diagram showing a conventional arrangement wherein the reference picture is stored in the memory by a frame-organized storage method. In the frame-organized storage method, a reference-frame-picture is directly stored in a frame buffer 1. On the other hand, the reference-top-field-picture and the reference-bottom-field-picture are interlaced and combined as a frame structure, and then stored into a frame buffer 1. FIG. 1 illustrates a page 10 stored in a frame buffer 1. Please note that in this drawing, each address is directed to double words (4 bytes) of data. The picture has 720*576 pixels, and contains 720*576 bytes of data if each pixel is represented by one byte of data, so the frame buffer 1 contains 720*576 bytes of data. Each page has 32*32=1,024 bytes of data, and includes four 16*16 bytes macroblocks 11, 12, 13 and 14. As described above, each macroblock includes a portion of the top and bottom fields, wherein the shadowed areas denote the bottom field in this drawing. There are two drawbacks for this conventional frame-organized storage method. First, for accessing the top or bottom field in a field-based prediction, the above-mentioned DRAM burst-access mode can't be used since the accessed addresses are not consecutively located. For example, if we want to read the top field of the macroblock 11 in FIG.1, the read address will be 0, 2, 4, 8, 10, 12, 14 and 16. Since these access addresses are not consecutively located, we can't use DRAM burst access mode to read these data. Hence, the next row-activation command overhead cycles can't be concealed and accomplished during current DRAM burst access. So the effective DRAM bandwidth will be substantially decreased. Secondly, when we use a DRAM with wider data bus width, the field accessing of top or bottom field in a field-based prediction will become inefficient. For example, if the DRAM data bus width increases from 32 bits to 64 bits, the data amount we can fetch at one time increases from one double word to two double words. If we want to access the top field of the reference picture only, the DRAM access will become inefficient because some unnecessary data, i.e. bottom field of the reference picture, will also be fetched and then discarded.

FIG. 2 is a diagram showing a conventional arrangement wherein the reference picture is stored in the memory by a field-organized storage method. In the field-organized storage method, the reference-top-field-picture and the reference-bottom-field-picture are respectively stored in different field buffers. On the other hand, the reference-frame-picture is composed of a reference-top-field-picture and a reference-bottom-field-picture, which are stored in different field buffers. Also, assuming the picture has 720*576 pixels, and contains 720*576 bytes of data if each pixel is represented by one byte of data, each of the field buffer 2 and 2′ has 720*288 bytes of data. The field buffer 2 and 2′ are different portions of a memory. The page 20 has 32*32 bytes of data, and stores eight portions of the top field, indicated as 21 to 28 in FIG. 2(A); the page 20′ has also 32*32 bytes of data, and stores eight portions of the bottom field, indicated as 21′ to 28′ in FIG. 2(B). In the field-organized method, since the top and bottom fields are stored in different field buffers 2, 2′, the corresponding top and bottom fields of each macroblock will be stored in different pages. Although the field-organized method can avoid the two drawbacks of the frame-organized method, another disadvantage occurs in the frame access of a frame-based prediction. When a system perform the frame access in a frame-based prediction so as to fetch both the top and bottom field data, cross page penalties will occur since the top and bottom fields of each macroblock are stored in different pages. Hence, the effective DRAM bandwidth of field-organized method will be lowered due to the inevitable cross page penalties of frame access.

### SUMMARY OF THE INVENTION

In view of the above-mentioned problems, it is therefore an object of the invention to provide a memory access method for video decoding in which a reference picture is stored in a memory in the unit of macroblocks, and the corresponding top and bottom field of each macroblock are separately stored in different consecutive addressing areas of pages. According to this method, a system can fully utilize DRAM burst mode for both frame and field access to substantially increase effective DRAM bandwidth. Furthermore, we can avoid inefficient DRAM access for wider DRAM data bus width in the frame-organized method, and avoid undesirable cross-page penalty in frame access in the field-organized method.

To achieve the above-mentioned objects, a new method of storing pixel data of a reference picture and retrieving a prediction block of the reference picture from a memory is provided. According to the preferred embodiments, the memory is divided into several pages. The reference picture consists of a top field and a bottom field, and is divided into several macroblocks. Each macroblock has a corresponding portion of the top field and the bottom field of the reference picture. The method includes the steps of: dividing each page into a top-section having one or more consecutive addressing area and a bottom-section having one or more consecutive addressing areas; storing the corresponding top field of the macroblocks into the top-sections, and the corresponding bottom field of the macroblocks into the bottom-sections; and then retrieving the pixel data of the prediction block stored in the memory in a page-by-page manner.

### BRIEF DESCRIPTION OF THE DRAWINGS

FIG. 1 is a diagram showing a conventional arrangement wherein the reference picture is stored in the memory in the unit of macroblocks.

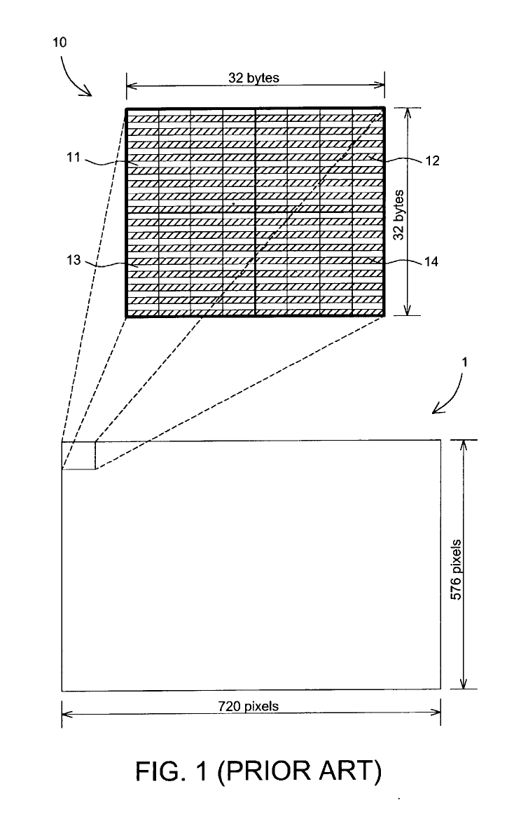

FIG. 2 is a diagram showing another conventional arrangement wherein the reference picture is stored in the memory in the unit of macroblocks.

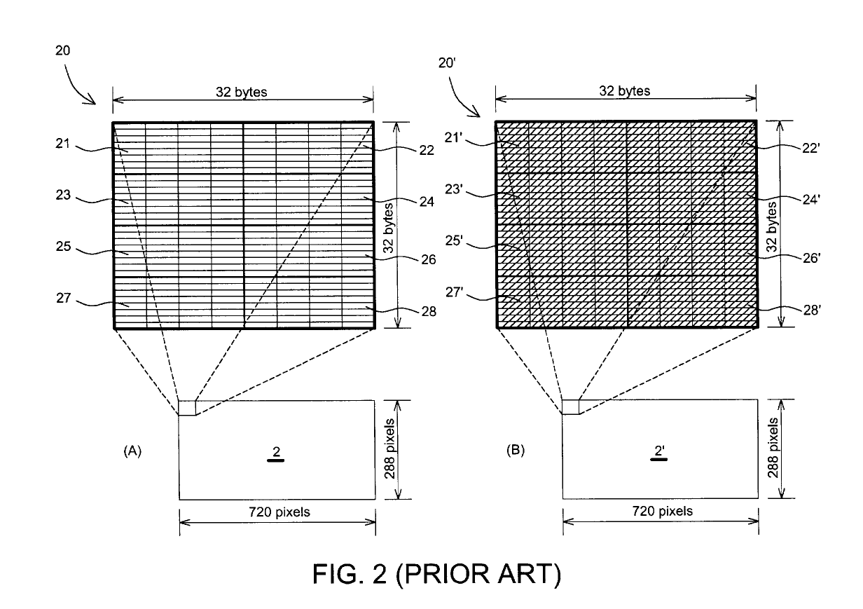

FIG. 3 is a schematic illustration showing the reference picture divided in the unit of macroblocks according to the first embodiment of the present invention.

FIG. 4 is a diagram showing an arrangement wherein the reference picture is stored in the memory in the unit of macroblocks according to the first embodiment of the invention.

FIG. 5 is a schematic illustration showing the corresponding memory addresses when the reference picture is stored in the memory in the unit of macroblocks according to the first embodiment of the invention.

FIG. 6 is another schematic illustrations showing the memory addressing areas of the top and bottom field data in a page according to the second embodiment of the invention.

FIG. 7 is another schematic illustrations showing the memory addressing areas of the top and bottom field data in a page according to the third embodiment of the invention.

### DETAILED DESCRIPTION OF THE INVENTION

The memory access method for video decoding of the preferred embodiments will be described with reference to the accompanying drawings. Although the MPEG format is described as an example of the memory access method of the invention, the scope of the invention is not limited thereto.

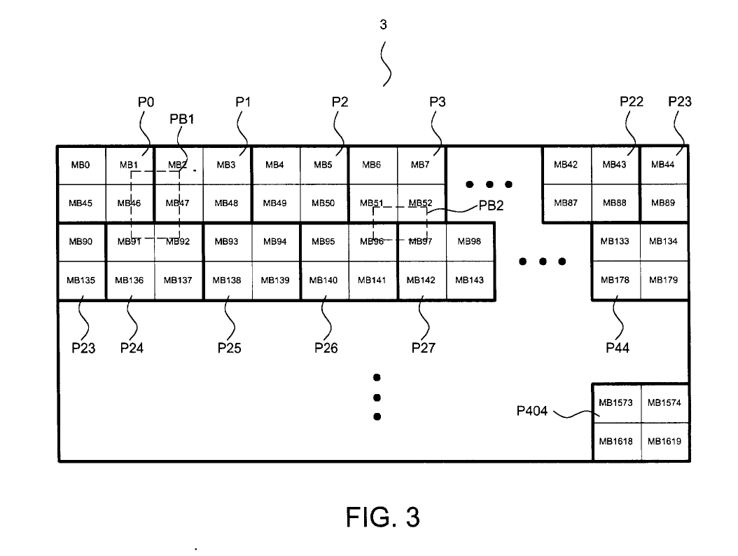

FIG. 3 illustrates the pixel data of a reference picture of 720*576 pixels divided into many macroblocks. Assuming each pixel is represented by one byte of data, and then the reference picture 3 contains 720*576 bytes of data. In this embodiment the size of each macroblock is 16*16 pixels according to the definition of MPEG, so the data quantity of each macroblock is 256 bytes, and each macroblock includes a corresponding portion of the top field and the bottom field of the reference picture. Consequently, the reference picture is divided into 45*36 macroblocks, which are respectively denoted as MB0 to MB1619 in this drawing. Then, the number of macroblocks stored in each page is calculated according to the size of the page. Assuming the size of each page is 1,024 bytes in this embodiment, four macroblocks can be stored in one page since the size of each macroblock is 256 bytes.

After the number of macroblocks stored in each page of the memory is calculated and obtained, we store neighboring macroblocks in the reference picture into the page. In this embodiment, four macroblocks can be stored in one page, so every four (2*2) macroblocks may be regarded as one set of macroblocks for being sequentially stored into each corresponding page. The overall 1,620 macroblocks can be grouped as 404 sets of macroblocks, and can be stored into 404 pages of the memory.

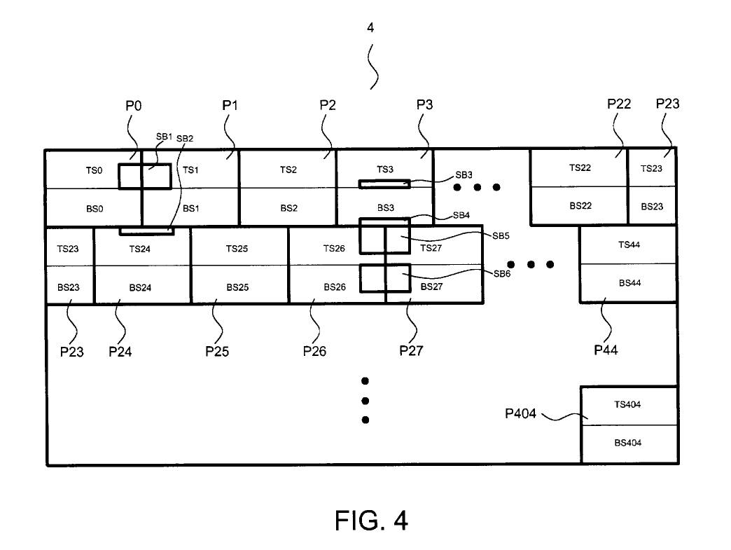

FIG. 4 illustrates the 404 sets of macroblocks are stored into the 404 pages of a buffer 4 according to one embodiment of the present invention. The buffer 4 is a portion of a memory, such as DDR SDRAM or RDRAM. Each page of the memory is divided into a top-section and a bottom-section. The top-section includes several consecutive addressing areas, and so is the bottom-section. The corresponding top field of the macroblocks belonging to this page is stored into the consecutive addressing areas of the top-section, and the corresponding bottom field of the macroblocks belonging to this page is stored into the consecutive addressing areas of the bottom-section.

As shown in FIG. 4, the corresponding top and bottom field of the four macroblocks of each page are separated, and respectively stored in the top-sections TS0 to TS404 and the bottom-sections BS0 to BS404. The shadowed areas shown in FIG. 4 denote the bottom-sections for the bottom fields.

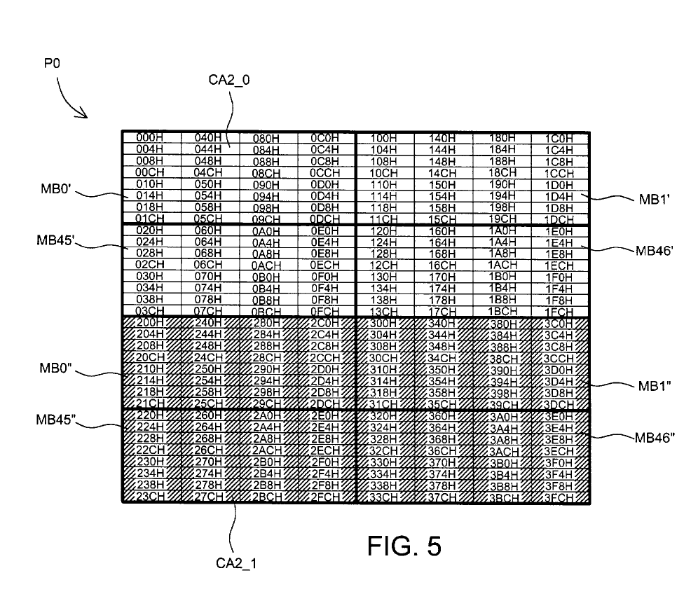

FIG. 5 is a schematic illustration for further illustrating the memory addressing areas of the top and bottom sections in a page. The page is divided into a top-section TS0 and a bottom-section BS0. The top-section TS0 contains a consecutive addressing area CA2_{—}0, and the bottom-section BS0 contains a consecutive addressing area CA2_{—}1. In this drawing, each address is a byte address. That is, each address is directed to one byte of data. The addressing area CA2_{—}0 contains the addresses from 000H to 1FFH, and the addressing area CA2_{—}1 contains the addresses from 200H to 3FFH. In each of the consecutive addressing areas, the available addresses are consecutive. The corresponding top field of the four macroblocks for each page is stored in the consecutive addressing area CA2_{—}0 of the top-section TS0, and the corresponding bottom field of the four macroblocks is stored in the consecutive addressing area CA2_{—}1 of the bottom-section BS0 (indicated as shadowed areas in FIG. 5). Assuming the data bus width in the system is 32 bits (double word) and each storage unit shown in the drawing is also set to be double words (4 bytes), then the page P0 stores the data of the corresponding top field of the macroblock MB0 into the addresses of 000H˜01FH, 040H˜05FH, 080H˜09FH and 0C0H˜0DFH, and stores the data of the corresponding bottom field of the macroblock MB0 into the addresses of 200H˜21FH, 240H˜25FH, 280H˜29FH and 2C0H˜2DFH. The addressing areas of the corresponding top and bottom field of MB 1, MB 45, and MB 46 is also illustrated in FIG. 5, accordingly. However, the addressing areas for storing the data of the corresponding top and bottom fields of the four macroblocks into a page is not limited to the above addressing sequence. Other addressing sequences which store the corresponding top field or bottom field of the macroblocks belonging to a page into the top-section or the bottom-section may also be adopted here. For example, the page P0 can also store the data of the corresponding top field of the macroblocks MB0, MB45, MB1 and MB46 into the area of 000H˜07FH, 080H˜0FFH, 100H˜17FH, and 180H˜1FFH, respectively, and store the corresponding bottom field of the macroblocks MB0, MB45, MB1 and MB46 into the area of 200H˜27FH, 280H˜2FFH, 300H˜37FH, and 380H˜3FFH, respectively.

After the method of storing the pixel data of a reference picture into a memory is described, we now illustrate the method of retrieving the prediction blocks of the reference picture in this embodiment. The dashed rectangles shown in FIG. 3 indicate the positions of several prediction blocks. In an example, there are two prediction blocks PB1 and PB2 in FIG. 3 and FIG. 4. The prediction block PB1 has a size of 16*33 bytes, and the prediction block PB2 has a size of 16*16 bytes. The procedure of reading pixel data of the prediction blocks PB1 and PB2 according to this embodiment will be described herein.

Firstly, we illustrate the field access method in this embodiment by reading only the top field of the prediction block PB1. The to-be-read areas include sub-areas SB1 and SB2, as shown in FIG. 4. Thus, the pages that are to be read when retrieving the pixel data of the prediction block PB1 include pages P0, P1, and P24. As shown in the drawing, the sub-area SB1 is distributed over the pages P0 and P1, while the sub-area SB2 is distributed over the page P24. The data belonging to different pages are sequentially read in a page-by-page manner in this embodiment so as to reduce the number of cross-pages. That is, the data of the sub-area SB1 within the page P0 is read first. Then, the data of the sub-area SB1 within the page P1 is read. Finally, the data of the sub-area SB2 within the page P24 is read. It should be noted that the sequence of reading these different pages may also be varied accordingly the spirit of the present invention.

Compared with the conventional frame-organized method, since the top field of the macroblocks are consecutively addressed in this embodiment, we can easily use DRAM burst access mode to burst access these top field and conceal the next row-activation command overhead cycles during current DRAM burst access. Therefore, the effective DRAM bandwidth can be greatly increased. Besides, when we use a DRAM with wider data bus width, the field access of the top field for the field-based prediction in this embodiment is also more efficient than the conventional frame-organized storage method because no unnecessary bottom field data will be fetched and then discarded. The above description illustrates accessing the top field of the prediction block using the DRAM burst access mode according to one embodiment. Similarly, the DRAM burst access mode can also be used to burst access the bottom field of the prediction block. Details will not be described for brevity.

Secondly, we illustrate the frame access method in this embodiment by reading both the top field and the bottom field of the prediction block PB2. The to-be-read areas include the sub-areas SB3 to SB6, as shown in FIG. 4. Thus, the pages that are to be read in this example include pages P3, P26 and P27. The sub-areas SB3 and SB4 are distributed over the page P3, while the sub-areas SB5 and SB6 are distributed over the pages P26 and P27. The data belonging to different pages are sequentially read in a page-by-page manner so as to reduce the number of cross-pages. That is, the data of the sub-areas SB3 and SB4 within the page P3 are read first in this embodiment. Then, the data of the sub-areas SB5 and SB6 within the page P26 are read. Finally, the data of the sub-areas SB5 and SB6 within the page P27 are read.

Compared with the conventional field-organized storage method, since the top field and bottom field of each macroblock are stored in the same page in this embodiment, the number of cross-pages can be substantially reduced since there will be no cross-page penalties when it is required to read both the top and bottom field of the same macroblock. Furthermore, since the top field or bottom field of a macroblock are consecutive addressed in this embodiment, we can easily use DRAM burst access mode to burst access these top field or bottom field and conceal the next row-activation command overhead cycles during current DRAM burst access. Therefore, the effective DRAM bandwidth can be increased.

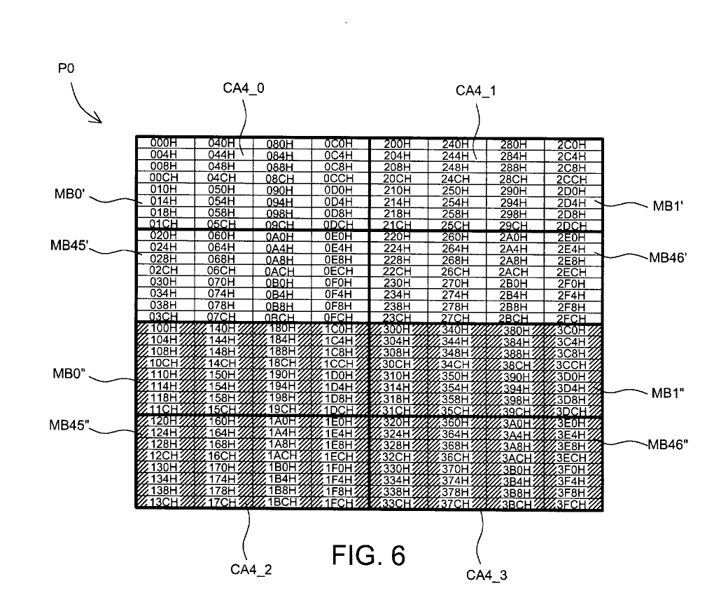

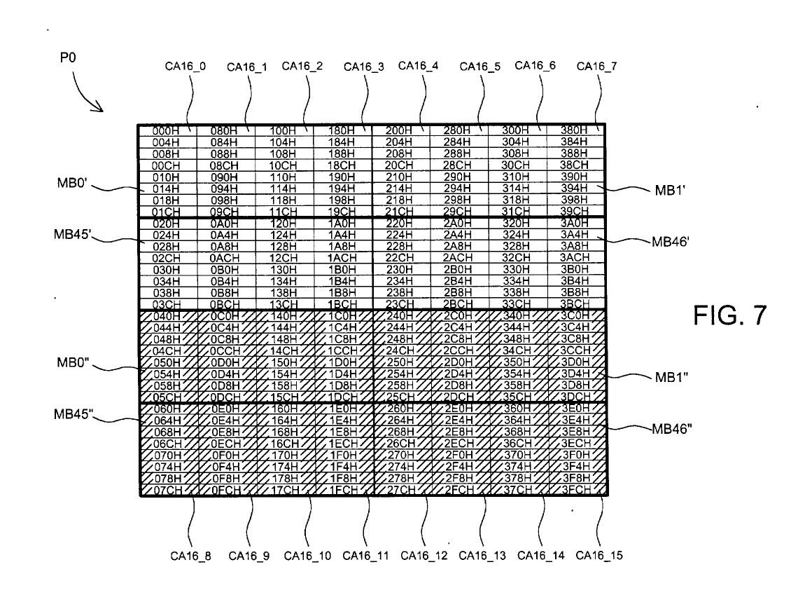

FIGS. 6 and 7 illustrate another two embodiments of the memory addressing areas of the top and bottom field in a page according to the present invention. In the first embodiment as shown in FIG. 5, each page of the memory is divided into a top-section TS0 having one consecutive addressing area CA2_{—}0, and a bottom-section BS0 having one consecutive addressing area CA2_{—}1. In the second embodiment as shown in FIG. 6, a page P0 is divided into a top-section TS0 having two consecutive addressing areas CA4_{—}0, CA4_{—}1, and a bottom-section BS0 having two consecutive addressing areas CA4_{—}2, and CA4_{—}3. The consecutive addressing area CA4_{—}0 contains the addresses from 000H to 0FFH; the consecutive addressing area CA4_{—}1 contains the addresses from 200H to 2FFH; the consecutive addressing area CA4_{—}2 contains the addresses from 100H to 1FFH; and the consecutive addressing area CA4_{—}3 contains the addresses from 300H to 3FFH. In each of the consecutive addressing areas, the available addresses are consecutive. The data of the corresponding top field of the four macroblocks are stored into the two consecutive addressing areas CA4_{—}0 and CA4_{—}1 of the top-section TS0, and the data of the corresponding bottom field of the four macroblocks are stored into the two consecutive addressing areas CA4_{—}2, and CA4_{—}3 of the bottom-section BS0. More particularly in this embodiment, the data of the corresponding top field of MB0 and MB45 are stored into the consecutive addressing area CA4_{—}0 of the top-section TS0, and the data of the corresponding top field of MB1 and MB46 are stored into the consecutive addressing area CA4_{—}1 of the top-section TS0. The data of the corresponding bottom field of MB0 and MB45 are stored into one consecutive addressing area CA_{—}4_{—}2 of the bottom-section BS0, and the data of the corresponding bottom field of MB1 and MB46 are stored into the consecutive addressing area CA4_{—}3 of the bottom-section BS0.

In the third embodiment as illustrated in FIG. 7, a page P0 is divided into sixteen consecutive addressing areas CA16_{—}0 to CA16_{—}15. The top-section TS0 contains eight consecutive addressing areas CA16_{—}0 to CA16_{—}7, and the bottom-section BS0 contains another eight consecutive addressing areas CA16_{—}8 to CA16_{—}15. In this drawing, the consecutive addressing area CA16_{—}0 contains the addresses from 000H to 03FH; CA16_{—}1 contains the addresses from 080H to 0BFH; CA16_{—}9 contains the addresses from 0C0H to 0FFH; and CA16_{—}15 contains the addresses from 3C0H to 3FFH, . . . etc. In each of the consecutive addressing areas, the available addresses are consecutive. The data of the corresponding top field of the four macroblocks are stored into eight consecutive addressing areas of the top-section TS0, while the data of the corresponding bottom field for the four macroblocks are stored into another eight consecutive addressing areas of the bottom-section BS0. More particularly in this embodiment, the top field of MB0 and MB45 are stored into four consecutive addressing areas CA16_{—}0 to CA16_{—}3 of the top-section TS0, and the data of top field of MB1 and MB46 are stored into another four consecutive addressing area CA16_{—}4 to CA16_{—}7 of the top-section TS0. The bottom field of MB0 and MB45 are stored into four consecutive addressing areas CA16_{—}8 to CA16_{—}11 of the bottom-section BS0, and the data of bottom field of MB1 and MB46 are stored into another four consecutive addressing area CA16_{—}12 to CA16_{—}15 of the bottom-section BS0.

In the above embodiments, the top-section comprises a same number of consecutive addressing areas as of the bottom-section. However, people skilled in the art will appreciate that the top-section and the bottom-section may comprise different numbers of consecutive addressing areas according to the spirit of the invention. For the sake of brevity, the further details will not be redundantly described here.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

What is claimed is:

1. A method of storing pixel data of a reference picture using a memory having a plurality of pages, the reference picture consisting of a top field and a bottom field and being divided into a plurality of macroblocks, each macroblock having a corresponding top field and a corresponding bottom field, the method comprising the steps of:
dividing each of the plurality of pages into a top-section having at least one consecutive addressing areas and a bottom-section having at least one consecutive addressing areas; and
storing the corresponding top field and the corresponding bottom field of the macroblocks into the top-sections and the bottom-sections, respectively.

2. The method of claim 1, wherein the top-section and the bottom-section comprise same numbers of consecutive addressing areas.

3. The method of claim 1, wherein the top-section and the bottom-section comprise different numbers of consecutive addressing areas.

4. The method of claim 1, wherein the corresponding top field and the corresponding bottom field of one of the plurality of macroblocks are stored in one consecutive addressing area in the top-section and bottom-section, respectively.

5. The method of claim 1, wherein the corresponding top field and the corresponding bottom field of one of the plurality of macroblocks are stored in more than one consecutive addressing areas in the top-section and bottom-section, respectively.

6. The method of claim 1, wherein the size of the top-section and the bottom-section are capable of storing the corresponding top field and bottom field of at least one macroblock, respectively.

7. The method of claim 1, wherein each of the plurality of pages has a size of 1,024 bytes.

8. The method of claim 1, wherein each of the plurality of macroblocks has a size of 16*16 bytes.

9. A method of storing and retrieving pixel data of a reference picture using a memory having a plurality of pages, the reference picture consisting of a top field and a bottom field and being divided into a plurality of macroblocks, each macroblock having a corresponding top field and a corresponding bottom field, the method comprising the steps of:
dividing each of the plurality of pages into a top-section having at least one consecutive addressing areas and a bottom-section having at least one consecutive addressing areas;
storing the corresponding top field and the corresponding bottom field of the macroblocks into the top-sections and the bottom-sections, respectively; and
retrieving the pixel data stored in the memory in a page-by-page manner.

10. The method of claim 9, wherein the corresponding top field and the corresponding bottom field of one of the plurality of macroblocks are stored in one consecutive addressing area in the top-section and bottom-section, respectively.

11. The method of claim 9, wherein the corresponding top field and the corresponding bottom field of one of the plurality of macroblocks are stored in more than one consecutive addressing areas in the top-section and bottom-section, respectively.

12. The method of claim 9, wherein the size of the top-section and the bottom-section are capable of storing the corresponding top field and bottom field of at least one macroblock, respectively.

13. A method of storing pixel data of a reference picture and retrieving a prediction block of the reference picture using a memory having a plurality of pages, the reference picture consisting of a top field and a bottom field and being divided into a plurality of macroblocks, each macroblock having a corresponding top field and a corresponding bottom field, the pixel data of the prediction block being stored in a first page and a second page, the method comprising the steps of:
dividing each of the plurality of pages into a top-section having at least one consecutive addressing areas and a bottom-section having at least one consecutive addressing areas;
storing the corresponding top fields and the corresponding bottom field of the macroblocks into the top-sections and bottom-sections, respectively; and
retrieving all the pixel data of the prediction block stored in the first page, and then retrieving all the pixel data of the prediction block stored in the second page.

14. The method of claim 13, wherein the corresponding top field and the corresponding bottom field of one of the plurality of macroblocks are stored in one consecutive addressing area in the top-section and bottom-section, respectively.

15. The method of claim 13, wherein the corresponding top field and the corresponding bottom field of one of the plurality of macroblocks are stored in more than one consecutive addressing areas in the top-section and bottom-section, respectively.

16. The method of claim 13, wherein the size of the top-section and the bottom-section are capable of storing the corresponding top field and bottom field of at least one macroblock, respectively.
